(19) United States
(12) Patent Application Publication
(10) Pub. No.: US 2024/0126148 A1
(43) Pub. Date: Apr. 18, 2024

(54) VIBRATION DAMPING ASSEMBLY

(71) Applicant: Mason McCormack, Boston, MA (US)

(72) Inventor: Mason McCormack, Boston, MA (US)

(21) Appl. No.: 17/965,640

(22) Filed: Oct. 13, 2022

(51) Int. Cl. G03B 17/56; F16F 3/087; F16F 15/08

(52) U.S. Cl. CPC G03B 17/561; F16F 3/0873; F16F 15/08; F16F 2224/02

(57) ABSTRACT

Provided herein is a vibration damping assembly for mounting and isolating optical elements (e.g., telescopes, or meteor cameras).

### BACKGROUND

A limitation of Earth-based astronomy is the transfer of ambient vibrations to the optical element (e.g., a telescope or camera), which may blur the images obtained from the optical device or otherwise compromise viewing, or recorded image or video quality.

### SUMMARY

This disclosure is based at least in-part on the inventors' discovery of a vibration damping mount that is effective for reducing and/or eliminating ambient vibrations from transferring to an optical element when mounted to a surface.

In certain aspects, disclosed herein is a vibration damping assembly for mounting one or more optical elements, comprising:
a first constraining layer having an upper surface and a lower surface disposed opposite the upper surface;
a second constraining layer having an upper surface and a lower surface disposed opposite the upper surface;
a third constraining layer having an upper surface and a lower surface disposed opposite the upper surface;
a first damping layer disposed between the first and second constraining layers; and
a second damping layer disposed between the second and third constraining layers; wherein:
the second constraining layer is disposed between the lower surface of the first constraining layer and the upper surface of the third constraining layer;
the upper surface of the second constraining layer is proximal the lower surface of the first constraining layer and the lower surface of the second constraining layer is proximal the upper surface of the third constraining layer;
the first damping layer comprises a plurality of viscoelastic connecting members each contacting both the lower surface of the first constraining layer and the upper surface of the second constraining layer; and
the second damping layer comprises a plurality of viscoelastic connecting members each contacting both the lower surface of the second constraining layer and the upper surface of the third constraining layer.

### BRIEF DESCRIPTION OF THE DRAWINGS

FIG. 1 shows a schematic diagram of a vibration damping camera mount.

FIGS. 2A-C show a schematic of an exemplary configuration for a series of constraining and damping layers.

### DETAILED DESCRIPTION OF CERTAIN EMBODIMENTS OF THE INVENTION

In one aspect, disclosed herein is a vibration damping assembly for mounting one or more optical elements, comprising:
a first constraining layer having an upper surface and a lower surface disposed opposite the upper surface;
a second constraining layer having an upper surface and a lower surface disposed opposite the upper surface;
a third constraining layer having an upper surface and a lower surface disposed opposite the upper surface;
a first damping layer disposed between the first and second constraining layers; and
a second damping layer disposed between the second and third constraining layers;
wherein:
   the second constraining layer is disposed between the lower surface of the first constraining layer and the upper surface of the third constraining layer;
   the upper surface of the second constraining layer is proximal the lower surface of the first constraining layer and the lower surface of the second constraining layer is proximal the upper surface of the third constraining layer;
   the first damping layer comprises a plurality of viscoelastic connecting members each contacting both the lower surface of the first constraining layer and the upper surface of the second constraining layer; and
   the second damping layer comprises a plurality of viscoelastic connecting members each contacting both the lower surface of the second constraining layer and the upper surface of the third constraining layer.

In certain embodiments, each of the first, second, and third constraining layers independently comprises a rigid constraining material. In certain embodiments, the first constraining layer comprises a rigid constraining material. In certain embodiments, the second constraining layer comprises a rigid constraining layer. In certain embodiments, the third constraining layer comprises a rigid constraining layer. In certain embodiments, each of the first, second, and third constraining layers independently comprises the same rigid constraining material. In certain embodiments, each of the first, second, and third constraining layers independently comprises different rigid constraining materials. In certain embodiments, each rigid constraining material independently comprises a sheet. In certain embodiments, each constraining material independently comprises plywood. In certain embodiments, each of the constraining layers comprises plywood. In certain embodiments, each of the constraining layers comprises a plywood sheet. In certain embodiments, each of the constraining layers comprises a 12″×12″ plywood sheet. In certain embodiments, the plywood sheet is 6 mm thick.

In certain embodiments, the vibration damping assembly comprises additional constraining layers and additional damping layers. In certain embodiments, the vibration damping assembly comprises additional constraining layers (e.g., 4, 5, or 6), each with additional damping layers disposed between the additional constraining layers. In certain embodiments, the vibration damping assembly comprises a fourth constraining layer having an upper surface and a lower surface disposed opposite the upper surface; and a third damping layer disposed between the third and fourth constraining layers, the third damping layer comprising a plurality of viscoelastic connecting members each contacting both the lower surface of the third constraining layer and the upper surface of the fourth constraining layer. In certain embodiments, the vibration damping assembly comprises a fifth constraining layer having an upper surface and a lower surface disposed opposite the upper surface; and a fourth damping layer disposed between the fourth and fifth constraining layers, the fourth damping layer comprising a plurality of viscoelastic connecting members each contacting both the lower surface of the fourth constraining layer and the upper surface of the fifth constraining layer. In certain embodiments, the vibration damping assembly comprises a sixth constraining layer having an upper surface and a lower surface disposed opposite the upper surface; and a fifth damping layer disposed between the fifth and sixth constraining layers, the fifth damping layer comprising a plurality of viscoelastic connecting members each contacting both the lower surface of the fifth constraining layer and the upper surface of the sixth constraining layer. In certain embodiments, the vibration damping assembly comprises a total of four constraining layers and three damping layers, configured in a manner similar to that discussed above. In certain embodiments, the vibration damping assembly comprises a total of five constraining layers and four damping layers, configured in a manner similar to that discussed above. In certain embodiments, the vibration damping assembly comprises a total of six constraining layers and five damping layers, configured in a manner similar to that discussed above.

In certain embodiments, the constraining layer further comprises a water-resistant material. In certain embodiments, the water-resistant material is a paint or gloss. In certain embodiments, the constraining layer comprises the water-resistant material on each of the outer surfaces of the constraining layer.

In certain embodiments, further comprising an optical mount configured for mounting an optical device, affixed to the upper surface of the first constraining layer.

In certain embodiments, the lower surface of the third constraining layer is configured for attachment to a surface. In certain embodiments, the surface is substantially planar. In certain embodiments, the substantially planar surface is in or on a building. In certain embodiments, the substantially planar surface is in or on the uppermost surface of a building. In certain embodiments, the substantially planar surface is a rooftop.

In certain embodiments, the lower surface of the lowermost constraining layer is transiently, semi-permanently, or permanently attached to the substantially planar surface. attachment is transient, semi-permanent, or permanent. In certain embodiments, the lowermost constraining layer is the third constraining layer. In certain embodiments, the lowermost constraining layer is the fourth constraining layer. In certain embodiments, the lowermost constraining layer is the fifth constraining layer. In certain embodiments, the lowermost constraining layer is the sixth constraining layer. In certain embodiments, the lower surface of the lowermost constraining layer is transiently to the substantially planar surface. In certain embodiments, the lowermost constraining layer is transiently to the substantially planar surface using a removable adhesive. In certain embodiments, the removable adhesive is glue. In certain embodiments, the removable adhesive is hot glue. In certain embodiments, the removable adhesive is superglue. In certain embodiments, the lower surface of the lowermost constraining layer is semi-permanently attached to the substantially planar surface. In certain embodiments, the lower surface of the lowermost constraining layer is semi-permanently attached to the substantially planar surface using nails, screws, or staples. In certain embodiments, the lower surface of the lowermost constraining layer is permanently attached to the substantially planar surface. In certain embodiments, the lower surface of the lowermost constraining layer is permanently attached to the substantially planar surface using permanent adhesive, tacks, bolts, or rivets. In certain embodiments, the permanent adhesive is superglue. In certain embodiments, the permanent adhesive is epoxy.

In certain embodiments, each of the first and second damping layers independently comprises three to ten viscoelastic connecting members. In certain embodiments, the first damping layer comprises four viscoelastic connecting members. In certain embodiments, the second damping layer comprises eight viscoelastic connecting members. In certain embodiments, the first damping layer comprises four viscoelastic connecting members and the second damping layer comprises eight viscoelastic connecting members.

In certain embodiments, each viscoelastic connecting member is in the form of a viscoelastic hemisphere. In certain embodiments, each viscoelastic connecting member in a particular damping layer is in the form of a viscoelastic hemisphere having a largest cross-sectional dimension of between about 1″ and about 3″. In certain embodiments, the largest cross-sectional dimension is about 1.25″. In certain embodiments, the largest cross-sectional dimension is about 2″.

In certain embodiments, at least one of the viscoelastic connecting members comprises a thermoset polyurethane. In certain embodiments, at least one of the viscoelastic connecting members comprises a thermoset, polyether-based, polyurethane material. In certain embodiments, each viscoelastic connecting member in a particular damping layer comprises a thermoset polyurethane. In certain embodiments, each viscoelastic connecting member comprises a thermoset polyurethane. In certain embodiments, at least one of the viscoelastic connecting members comprises Sorbothane®. In certain embodiments, each viscoelastic connecting member in a particular damping layer comprises Sorbothane®. In certain embodiments, each viscoelastic connecting member comprises Sorbothane®.

In certain embodiments, the viscoelastic connecting members of the first damping layer comprise four thermoset polyurethane hemispheres each having a largest cross-sectional dimension of about 2″. In certain embodiments, the viscoelastic connecting members of the first damping layer comprise Sorbothane® hemispheres each having a largest cross-sectional dimension of about 2″. In certain embodiments, the viscoelastic connecting members of the second damping layer comprise eight thermoset polyurethane hemispheres each having a largest cross-sectional dimension of about 1.25″. In certain embodiments, the viscoelastic connecting members of the second damping layer comprise Sorbothane® each having a largest cross-sectional dimension of about 1.25″.

Sorbothane® is a proprietary, thermoset, polyether-based, polyurethane material that is viscoelastic such that it exhibits properties of both liquids (viscous solutions) and solids (elastic materials). Sorbothane® is available from Sorbothane, Inc. of Kent, Ohio (www.sorbothane.com).

In certain embodiments, the viscoelastic connecting members are affixed to the constraining layers by affixing means. In certain embodiments, the affixing means comprises one or more of adhesive, nails, screws, staples, tacks, bolts, rivets. In certain embodiments, the adhesive is glue. In certain embodiments, the glue is hot glue or superglue. In certain embodiments, the adhesive is epoxy. In certain embodiments, the affixing means comprises compression from the constraining layers contacting the viscoelastic connecting members.

In certain embodiments, the optical element is a camera. In certain embodiments, the optical element is an meteor camera. In certain embodiments, the optical element is a telescope.

In certain embodiments, the first and second constraining layers are affixed to one another by a first fastening means and the second and third constraining layers are affixed to one another by a second fastening means. In certain embodiments, the first and second fastening means are independently selected from one or more of the group consisting of screws, bolts, nails, rivets, and adhesive dowels. In certain embodiments, the first fastening means are screws. In certain embodiments, the second fastening means are screws.

### DETAILED DESCRIPTION OF THE FIGURES

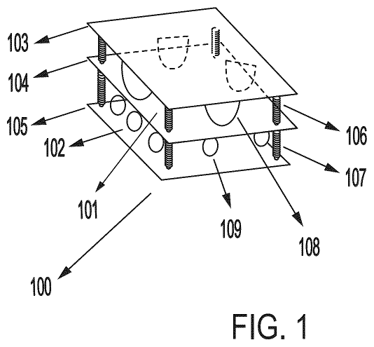

An exemplary vibration damping assembly 100 is show in FIG. 1. The assembly 100 includes a first constraining layer 103, a second constraining layer 104, and a third constraining layer 105. The assembly 100 further includes a first damping layer 101 disposed between the lower surface of the first constraining layer 103 and the upper surface of the second constraining layer 104. The first damping layer 101 includes 4 viscoelastic connecting members 108. The assembly 100 further includes a second damping layer 102 disposed between the lower surface of the second constraining layer 104 and the upper surface of the third constraining layer 105. The second damping layer 101 includes 8 viscoelastic connecting members 109. The assembly 100 further includes a first fastening means including four screws 106 that affixes the first and second constraining layers to one another. The assembly 100 further includes a second fastening means including four screws 107 that affixes the second and third constraining layers to one another.

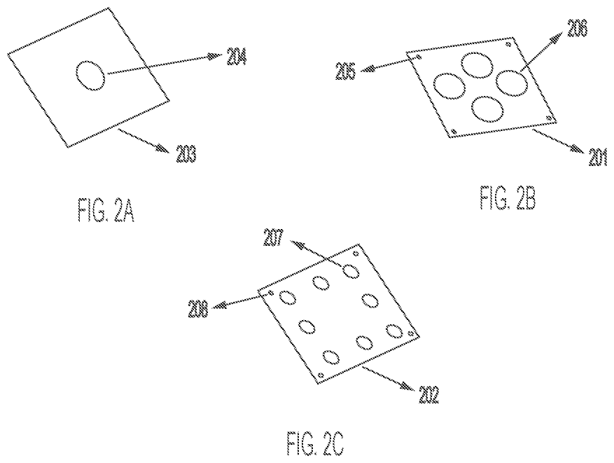

FIGS. 2A-C show breakdown views of the exemplary vibration damping assembly 100 shown in FIG. 1. FIG. 2A shows a top aspect view of a first constraining layer 203, with the upper surface shown. The first constraining layer 203 includes a mount for an optical element 204 affixed to the upper surface of the first constraining layer 203. FIG. 2B shows a top aspect view of the second constraining layer 201, with the upper surface shown. The second constraining layer 201 includes four viscoelastic connecting members 206 affixed to the upper surface of the second constraining layer 201. The second constraining layer 201 further includes four apertures 205 configured to receive fastening means to affix the second constraining layer to the first and/or constraining layers. FIG. 2C shows a top aspect view of the third constraining layer 202. The third constraining layer 202 includes eight viscoelastic connecting members 207 affixed to the upper surface of the third constraining layer 202. The third constraining layer 202 further includes four apertures 208 configured to receive fastening means to affix the third constraining layer to the second constraining layer.

### EXAMPLES

### Example 1. Construction of an Exemplary Damping Assembly

A damping assembly according to the present disclosure is assembled. Eight 1.25″ Sorbothane® hemispheres are affixed along the outer edge of the upper surface of a piece of 12″×12″ square plywood 6 mm thick. A second piece of a piece of 12″×12″ square plywood 6 mm thick is placed on top of the 1.25″ Sorbothane® hemispheres such that the lower surface of the second piece of plywood is contacting each of the 1.25″ Sorbothane® hemispheres. The second piece of plywood is fastened to the first piece of plywood with four screws, fastening each corner of the second piece of plywood to the corresponding corner of the first piece of plywood below. Four 2″ Sorbothane® hemispheres are then affixed in a diamond pattern on the upper surface of the second layer of plywood. A third piece of 12″×12″ square plywood 6 mm thick is placed on top of the four 2″ Sorbothane® hemispheres such that the lower surface of the third piece of plywood is contacting each of the 2″ Sorbothane® hemispheres. The third piece of plywood is fastened to the second piece of plywood with four screws, fastening each corner of the third piece of plywood to the corresponding corner of the second piece of plywood below. An optical mount configured to mount a meteor camera is affixed to the upper surface of the upper-most (third) piece of plywood. The bottom-most piece of plywood is attached to a building rooftop using hot glue.

### Example 2. Utilizing the Vibration Damping Assembly to Obtain Images with a Meteor Camera

After assembling the vibration damping assembly described in Example 1, a meteor camera is coupled to the optical mount. The camera is set to capture still images and video of meteors detected within the field of view over a period of several days, weeks, or months. It is expected that the damping assembly provides a stable mount for the meteor camera on top of the building, which will prevent the meteor camera from detaching unintentionally from the camera arm, e.g., as a result of building vibrations, such as from HVAC units. Furthermore, the images produced by the meteor camera are expected to have improved clarity and overall quality, reducing motion blur and focus issues as compared to using the same meteor camera without a vibration damping assembly as disclosed herein.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all of the group members are present in, employed in, or otherwise relevant to a given product or process.

Furthermore, the disclosure encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. In general, where the disclosure, or aspects of the disclosure, is/are referred to as comprising particular elements and/or features, certain embodiments of the disclosure or aspects of the disclosure consist, or consist essentially of, such elements and/or features. For purposes of simplicity, those embodiments have not been specifically set forth in haec verba herein. It is also noted that the terms “comprising” and “containing” are open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the disclosure, to the tenth of the unit of the lower limit of the range, unless the context clearly dictates otherwise.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present disclosure, as defined in the following claims.

What is claimed is:

1. A vibration damping assembly for mounting one or more optical elements, comprising:
a first constraining layer having an upper surface and a lower surface disposed opposite the upper surface;
a second constraining layer having an upper surface and a lower surface disposed opposite the upper surface;
a third constraining layer having an upper surface and a lower surface disposed opposite the upper surface;
a first damping layer disposed between the first and second constraining layers; and
a second damping layer disposed between the second and third constraining layers;
wherein:
the second constraining layer is disposed between the lower surface of the first constraining layer and the upper surface of the third constraining layer;
the upper surface of the second constraining layer is proximal the lower surface of the first constraining layer and the lower surface of the second constraining layer is proximal the upper surface of the third constraining layer;
the first damping layer comprises a plurality of viscoelastic connecting members each contacting both the lower surface of the first constraining layer and the upper surface of the second constraining layer; and
the second damping layer comprises a plurality of viscoelastic connecting members each contacting both the lower surface of the second constraining layer and the upper surface of the third constraining layer.

2. The vibration damping assembly of claim 1, wherein each of the first, second, and third constraining layers independently comprises a rigid constraining material.

3. The vibration damping assembly of claim 2, wherein each rigid constraining material independently comprises a sheet.

4. The vibration damping assembly of claim 3, wherein each constraining material independently comprises plywood.

5. The vibration damping assembly of claim 1, further comprising an optical mount configured for mounting an optical device, affixed to the upper surface of the first constraining layer.

6. The vibration damping assembly of claim 5, wherein the optical device is a camera.

7. The vibration damping assembly of claim 6, wherein the optical device is a meteor camera.

8. The vibration damping assembly of claim 1, wherein the lower surface of the third constraining layer is configured for attachment to a substantially planar surface.

9. The vibration damping assembly of claim 8, wherein the substantially planar surface is a building.

10. The vibration damping assembly of claim 8, wherein the substantially planar surface is a rooftop.

11. The vibration damping assembly of claim 8, wherein the attachment is transient, semi-permanent, or permanent.

12. The vibration damping assembly of claim 1, wherein each of the first and second damping layers independently comprises three to ten viscoelastic connecting members.

13. The vibration damping assembly of claim 12, wherein the second damping layer comprises eight viscoelastic connecting members and the first damping layer comprises four viscoelastic connecting members.

14. The vibration damping assembly of claim 1, wherein each viscoelastic connecting member is in the form of a viscoelastic hemisphere.

15. The vibration damping assembly of claim 14, wherein the viscoelastic hemisphere comprises a thermoset polyurethane.

16. The vibration damping assembly of claim 14, wherein the viscoelastic hemisphere comprises Sorbothane®.

17. The vibration damping assembly of claim 12, wherein each viscoelastic connecting member is in the form of a viscoelastic hemisphere.

18. The vibration damping assembly of claim 17, wherein the viscoelastic hemisphere comprises a thermoset polyurethane.

19. The vibration damping assembly of claim 17, wherein the viscoelastic hemisphere comprises Sorbothane®.

20. The vibration damping assembly of claim 1, wherein:
the first and second constraining layers are affixed to one another by a first fastening means; and
the second and third constraining layers are affixed to one another by a second fastening means.

21. The vibration damping assembly of claim 1, wherein the first and second fastening means are selected from one or more of the group consisting of screws, bolts, nails, rivets, and adhesive dowels.
